(19) United States
(12) Patent Application Publication
(10) Pub. No.: US 2022/0317288 A1
(43) Pub. Date: Oct. 6, 2022

(54) VEHICLE-MOUNTED OBJECT DETECTION DEVICE

(71) Applicant: Mitsubishi Electric Corporation, Tokyo (JP)

(72) Inventor: Yuichi GODA, Tokyo (JP)

(73) Assignee: Mitsubishi Electric Corporation, Tokyo (JP)

(21) Appl. No.: 17/595,673

(22) PCT Filed: Aug. 2, 2019
(86) PCT No.: PCT/JP2019/030402

§ 371 Date: Nov. 22, 2021

(51) Int. Cl. G01S 13/931; G01S 7/40

(52) U.S. Cl. CPC G01S 13/931; G01S 7/40

(57) ABSTRACT

Provided herein are: multiple object detection units each serving to detect positional information about detection targets; a stationary object extraction unit for extracting, from positional information detected by two object detection units in the multiple object detection units about their respective sets of detection targets, positional information about multiple detection targets that are common between the respective sets of detection targets; and an axial deviation determination unit for making a comparison between the positional information detected by an object detection unit in the object detection units about the detection targets, and the positional information detected, after detection about the detection targets by the object detection unit, by the other detection unit about the detection targets, to thereby determine presence/absence of an axial deviation of a central axis of the object detection unit or the other object detection unit. According to this configuration, an axial deviation amount is detected.

### TECHNICAL FIELD

The present application relates to a vehicle-mounted object detection device.

### BACKGROUND ART

In Patent Document 1, an object detection device for vehicles is disclosed which includes: multiple detectors each serving to detect, using reflected waves, multiple detection points indicative of an object/objects, and being placed in a vehicle so that their respective detection points are partly overlapped with each other; and a detector identification unit that calculates an amount of relative axial deviation in the horizontal direction between two detectors in the multiple detectors by using the respective detection points inputted from the two detectors, to thereby identify the detector whose horizontal axis is misaligned, by using the thus-calculated relative axial deviation amount.

### CITATION LIST

### Patent Document

Patent Document 1: Japanese Patent Application Laid-open No. 2019-007934 (Paragraph 0023; FIG. 4)

### SUMMARY OF THE INVENTION

### Problems to be Solved by the Invention

According to the device in Patent Document 1, however, there is a problem that no comparison can be made between the detectors if they are not placed so that their respective detection points are overlapped with each other. Further, even if they are placed so that their respective detection points are overlapped with each other, there is a problem that, if there is no spot to be detected in a region where the respective detection points are located to be overlapped with each other, it is not possible to make estimation of the axial deviation.

This application discloses a technique for solving problems as described above, and an object thereof is to provide a vehicle-mounted object detection device which can detect an axial deviation amount without causing the detection regions of the multiple detectors to be overlapped with each other.

### Means for Solving the Problems

A vehicle-mounted object detection device disclosed in this application is characterized by comprising: multiple object detection units each serving to detect positional information about stationary objects; a stationary object extraction unit for extracting, from respective sets of positional information detected by two object detection units in the multiple object detection units about their respective sets of stationary objects, positional information about multiple stationary objects that are common between the respective sets of stationary objects; and an axial deviation determination unit for making a comparison between the positional information detected by one object detection unit in the two object detection units about the multiple stationary objects, and the positional information detected, after detection about the multiple stationary objects by the one object detection unit, by the other object detection unit in the two object detection units about the multiple stationary objects, to thereby determine presence/absence of an axial deviation of a central axis of the one object detection unit or the other object detection unit.

### Effect of the Invention

According to this application, after detection about the multiple stationary objects by the one object detection unit, their positional information is compared with the positional information detected thereafter by the other object detection unit about the multiple stationary objects, so that it is possible to detect the axial deviation amount without causing the detection regions of the multiple detectors to be overlapped with each other.

### BRIEF DESCRIPTION OF THE DRAWINGS

FIG. 1 is a schematic diagram showing a configuration of a vehicle-mounted object detection device according to Embodiment 1.

FIG. 2 is a block diagram showing a configuration of the vehicle-mounted object detection device according to Embodiment 1.

FIG. 3 is a flowchart showing operations of the vehicle-mounted object detection device according to Embodiment 1.

FIG. 4 is a diagram for illustrating a method of extracting a stationary object by the vehicle-mounted object detection device according to Embodiment 1.

FIG. 5 is a set of diagrams for illustrating a method of determining a relative axial deviation by the vehicle-mounted object detection device according to Embodiment 1.

FIG. 6 is a diagram for illustrating a method of estimating a relative axial deviation amount by the vehicle-mounted object detection device according to Embodiment 1.

FIG. 7 is a table showing an example of relative axial deviation amounts according to the vehicle-mounted object detection device according to Embodiment 1.

FIG. 8 is a set of diagrams for illustrating another method of determining a relative axial deviation by the vehicle-mounted object detection device according to Embodiment 1.

FIG. 9 is a set of diagrams for illustrating another method of determining a relative axial deviation by the vehicle-mounted object detection device according to Embodiment 1.

FIG. 10 is a set of diagrams for illustrating another method of determining a relative axial deviation by the vehicle-mounted object detection device according to Embodiment 1.

### MODES FOR CARRYING OUT THE INVENTION

### Embodiment 1

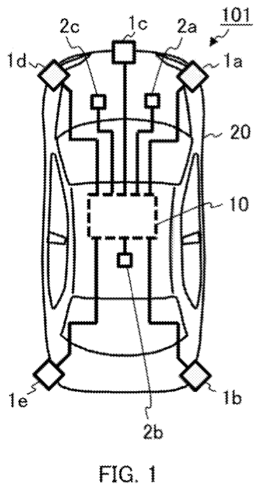

FIG. 1 is a schematic diagram showing a configuration of a vehicle-mounted object detection device 101 according to Embodiment 1 in this application. As shown in FIG. 1, the vehicle-mounted object detection device 101 is configured with: object detection units 1a, 1b, 1c, 1d, 1e each having an object detection function of outputting a distance, a relative speed, a horizontal angle and the like, to or toward a peripheral object; a control unit 10 for processing information from the object detection units in a collective manner; a vehicle control unit 2a for controlling a vehicle 20 in response to an instruction from the control unit 10; a yaw-rate sensor unit 2b for detecting a turning speed of the vehicle 20; and a traveling-speed sensor unit 2c for detecting a traveling speed of the vehicle 20. The object detection units are placed at five locations in the vehicle 20 on its front side (object detection unit 1c), right front side (object detection unit 1a), right rear side (object detection unit 1b), left front side (object detection unit 1d) and left rear side (object detection unit 1e).

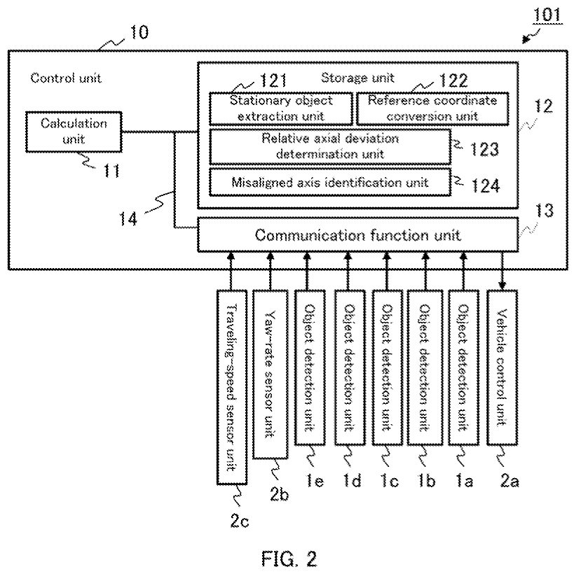

FIG. 2 is a block diagram showing a configuration of the vehicle-mounted object detection device 101 according to Embodiment 1 in this application. As shown in FIG. 2, the control unit 10 in the vehicle-mounted object detection device 101 is configured with a calculation unit 11, a storage unit 12, a communication function unit. 13 and a bus 14. The calculation unit 11, the storage unit 12 and the communication function unit 13 are connected to each other through the bus 14 in a bidirectionally communicable manner.

The calculation unit 11 is configured with an arithmetic device, such as, a “micon” (Microcomputer), a DSP (Digital Signal Processor) or the like. The storage unit 12 is configured with a RAM (Random Access Memory) and a ROM (Read Only Memory), and includes a stationary object extraction unit 121, a reference coordinate conversion unit 122, a relative axial deviation determination unit 123 and a misaligned axis identification unit 124.

The communication function unit 13, the object detection units 1a, 1b, 1c, 1d, 1e, the vehicle control unit 2a, the yaw-rate sensor unit 2b and the traveling-speed sensor unit 2c are connected to each other through signal lines. Detected information is inputted from the object detection units 1a, 1b, 1c, 1d, 1e, the yaw-rate sensor unit 2b and the traveling-speed sensor unit 2c, and a sensing result and drive control signals from the control unit 10 are outputted to the vehicle control unit 2a.

Here, each of the object detection units 1a, 1b, 1c, 1d, 1e is assumed to be a radar device as a sensor that radiates an electric wave and then receives a reflected wave thereof reflected off an object, to thereby detect positional information of the object, such as a distance, a relative speed, a horizontal angle and the like, to or toward that object. It may be any type of sensor other than the radar device, so far as it is configured to be capable of detecting the object, and thus may be a LIDAR (Light Detection and Ranging) sensor, an ultrasonic sensor, or the like. Further, here, description will be made citing a horizontal angle as an example; however, an axial deviation in the vertical direction can also be estimated when there is a function of measuring a vertical angle.

The yaw-rate sensor unit 2b is a sensor for detecting a turning motion of the vehicle 20, i.e., a sensor that detects a turning speed of the vehicle. As another means, a steering-wheel angle sensor or the like may instead be employed. The traveling-speed sensor unit 2c is a sensor for detecting a traveling speed of the vehicle 20, for example, a sensor that detects the rotation speed of the vehicle wheel.

It is noted that, though not illustrated in the figures, the control unit 10 may be configured to have a function of performing so-called “sensor fusion” processing—in which the relative velocities of the object detection units 1a, 1b, 1c, 1d, 1e, the distances thereof up to the object and the directions thereof toward the object (horizontal angles each made relative to the axial center of each of the object detection units) are combined together and/or with other sensing results from a monocular camera, a stereo camera, a LIDAR sensor, an ultrasonic sensor, etc.—thereby to transmit the sensor fusion result to the vehicle control unit, or to transmit a drive control signal for operating a vehicle control application on the basis of the sensor fusion result.

Further, the control unit 10 is operable when it receives outputs of at least two of the object detection units. Generally, in many cases, an object detection unit has a function of monitoring a measured value of an object at each given time and a function of tracking the measured value of the object after making identification in a time-serial manner; however, according to this application, the outputs of the object detection unit may be of any types so far as the relative speed, the distance to an object and the direction toward the object are outputted therefrom. For example, although the detection values themselves may be inputted to the control unit 10, a tracking function-based output (tracking result) may be inputted to the control unit 10, and in addition, a result from various processing performed later may be inputted to the control unit 10.

Further, the processing to be executed by the control unit 10 and the object detection units 1a, 1b, 1c, 1d, 1e may be divided or integrated in any manner. For example, it is allowed that the object detection unit 1a has a function of the control unit 10 so that all of the information is collected in the object detection unit 1a, and that a part of the function on the object detection units-side is instead incorporated into the control device-side.

Further, when the control unit 10 uses a tracking result, it is subject to the influence of tracking processing. For example, in the tracking processing, such an operation is generally performed in which the information of the relative speed, the distance, the direction, etc. is smoothed in a time-serial manner after identification is made; however, if the identification is made erroneously, the values of the relative speed, the distance, the direction, etc. after being smoothed will be deviated from their actually-measured values, resulting in an error factor. Since such an error depends also on the performance of the tracking processing, when the control unit is desired not to be subject to the influence of the tracking processing, it is preferable that the detection values themselves be inputted thereto.

Meanwhile, when the detection values themselves are used, the amount of data becomes larger relative to that in the case of employing the tracking processing. This is because, as the tracking result, such data for which identification is successful is outputted basically, whereas, in the case of the detection values, data is transmitted to the control device regardless of whether identification is successful or not. Accordingly, in such a case where there is a restriction of the amount of calculation on the control device-side, it is preferable to perform some kind of data reduction processing or to use a result of calculation after the tracking processing. Note that, in the following, description will be made about a case where the detection values themselves are inputted.

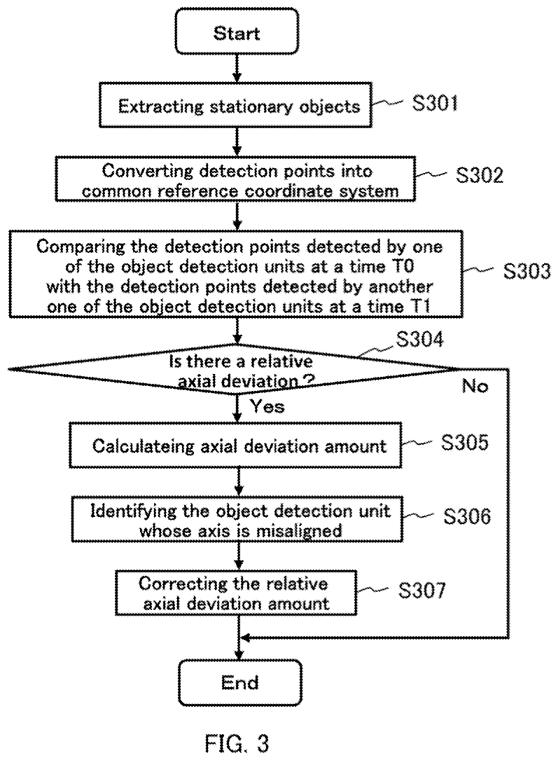

Next, operations of the vehicle-mounted object detection device 101 according to Embodiment 1 in this application will be described based on FIG. 3. FIG. 3 is a flowchart showing operational steps of the vehicle-mounted object detection device 101 according to Embodiment 1.

First of all, the stationary object extraction unit 121 in the control unit 10 uses the object detection units 1a, 1b, 1c, 1d, 1e to thereby extract non-moving objects (stationary objects) while taking into account the motion of the vehicle 20 (Step S301).

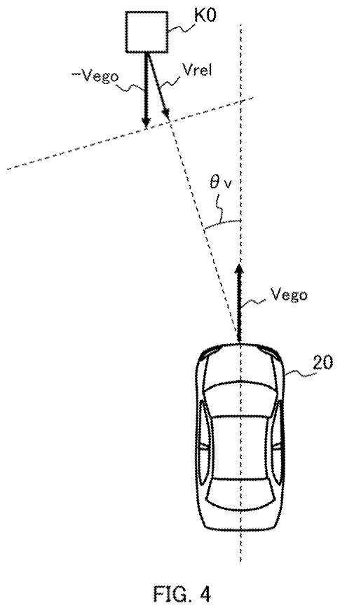

FIG. 4 is a diagram showing an example of how to extract a detection target K0 as a stationary object by the vehicle-mounted object detection device 101 according to Embodiment 1. As shown in FIG. 4, extraction of the detection target K0 is exemplified by such a method in which a traveling speed Vego of the vehicle 20 is detected by the traveling-speed sensor unit 2c, and a relative speed Vrel acquired by the object detection unit 1a, 1b, 1c, 1d or 1e is added to the traveling speed to thereby calculate a ground speed Vearth, and then, when the absolute value of the ground speed Vearth is less than a predetermined threshold value, the object is extracted as the detection target K0. A formula (1) for calculating the ground speed Vearth is shown below. Note that in the formula (1), the relative speed Vrel is defined to be negative when it is a speed in an approaching direction, and defined to be positive when it is a speed in a departing direction.

(Calculation Formula)

Vearth=Vego+Vrel (1)

It is noted that a method of detecting the traveling speed Vego of the vehicle 20 may be any type of method. For example, a publicly known technique of calculating the traveling speed Vego from the detection result acquired by the object detection units 1a, 1b, 1c, 1d and/or 1c may be employed.

Meanwhile, the relative speed Vrel measured by the object detection unit 1a, 1b, 1c, 1d or 1e depends on a horizontal angle made by the traveling direction of the vehicle 20 and the direction toward the detection target K0 as an object. When the horizontal angle made by the traveling direction and the direction toward the detection target K0 is assumed to be e, the relative speed Vrel measured by the object detection unit 1a, 1b, 1c, 1d or 1e varies depending on the horizontal angle θ, so that whether the object is a stationary object or not may be determined in consideration of that feature. Further, when the vehicle 20 is turning, the ground speed Vearth may be calculated in consideration of that turning. A formula (2) for calculating the ground speed Vearth in consideration of the horizontal angle θ is shown below.

(Calculation Formula)

Vearth=Vego×cos θ+Vrel (2)

Further, in Step S301, the stationary object extraction unit 121 is not necessarily required to transmit all data about the stationary objects, to where the processing of the next step is performed. For example, an object previously detected to have moved largely at a ground speed Vearth by using the object detection unit 1a, 1b, 1c, 1d or 1e, may possibly be stopping to just wait for a traffic light or the like, incidentally at a timing at which it is detected by the object detection unit 1a, 1b, 1c, 1d or 1e. On this occasion, there is a possibility that the previously moved object then moves again, so that the data about the previously moved object may be excluded from the output of the stationary object extraction unit 121 after execution of processing on a time-serial basis.

Further, according to the object detection units 1a, 1b, 1c, 1d, 1e, the higher the S/N ratio (SNR, Signal-to-Noise Ratio), the more accurate the detection value is. Thus, in order to improve the accuracy of the relative axial deviation determination unit 123, it is useful to transmit only the data of stationary objects having the S/N ratios each higher than a predetermined threshold value, to where the processing of the next step is performed.

Further, when there are multiple objects at almost the same distances and relative speeds, such a case may arise that the object detection unit 1a, 1b, 1c, 1d or 1e cannot distinguish the horizontal angles H of the respective objects from each other. A method capable of measuring the angles of the objects even when they exist at almost the same distances and relative speeds, is exemplified by angle measurement processing methods based on digital beam forming, MUSIC (Multiple Signal Classification), ESPRIT (Estimation of Signal Parameters via Rotational Invariance Techniques), maximum likelihood estimation and the like. However, even when such a method is employed, in some cases, the horizontal angles θ of the respective objects cannot be distinguished from each other, and in some other cases, the accuracy is not sufficient if they could be distinguished from each other. Accordingly, when there are multiple objects at almost the same distances and relative speeds, the data of the objects at these distances and relative speeds may be excluded from the output of the stationary object extraction unit 121. When there are multiple reflection objects at almost the same distances and relative speeds, whether or not to process the data thereof, may be determined according to the accuracy of the angle measurement processing method. Examples of how to make such determination according to the accuracy include a method in which, in the case where a same object is being identified in a time-serial manner by the tracking processing, when the horizontal angle of the object varies extremely largely, it is determined that the accuracy is degraded. Meanwhile, another method of determining whether or not multiple reflection objects exist at almost the same distances and relative speeds, is exemplified by a method in which arrival wave number estimation processing is performed that is publicly known in angle measurement processing.

Further, a feature in a road structure may be employed. For example, a continuous structure object such as a guard rail or the like has a characteristic shape (configuration). Thus, if, out of the acquired detection result, only the data of such a characteristic object in the road structure is transmitted in the subsequent step to the relative axial deviation determination unit 123, the processing in the subsequent step can be accomplished without such a reflection point detected just as a single point due to erroneous detection. This is useful to improve the accuracy of the relative axial deviation determination unit 123.

Subsequently, the reference coordinate conversion unit 122 in the control unit 10 converts the data extracted by using the object detection units 1a, 1b, 1c, 1d, 1e, into a relative coordinate system focused on the object detection units 1a, 1b, 1c, 1d, 1e (Step S302). In order to make, in the next step, a relative comparison between sets of detection points detected by the object detection units 1a, 1b, 1c, 1d, 1e, the reference coordinate conversion unit 122 converts these detection points into a common reference coordinate system.

Here, in a method for such conversion, the reference coordinate system is exemplified by a coordinate system with reference to the vehicle 20, a coordinate system with reference to a given one of the object detection units, or the like. For example, in the case where the object detection unit 1c is mounted on the front center of the vehicle 20 to be directed straightforward at a horizontal mounting angle of 0 degree so that the beam is outputted frontward from the vehicle 20, and the object detection unit 1a is mounted at a position that is placed 1 meter apart toward the right and 0.1 meter apart toward the rear of the vehicle 20 and at a horizontal mounting angle of 45 degrees, the detection points of the object detection unit. 1c are not subjected to coordinate conversion, but the detection points of the object detection unit 1b are subjected to the conversion to an extent corresponding to 1 meter being apart toward the right, 0.1 meter being apart toward the rear of the vehicle and the horizontal mounting angle of 45 degrees.

Then, the relative axial deviation determination unit 123 in the control unit 10 compares the detection points detected by one of the object detection units at a time T0 and converted into the reference coordinate system, with the detection points detected by another one of the object detection units at a time T1 and converted into the reference coordinate system (Step S303), and then determines whether there is a relative axial deviation, according to the relative comparison between sets of detection points in almost the same detection regions on the reference coordinate system (Step S304).

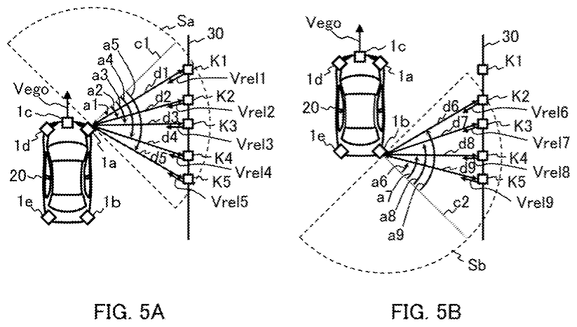

FIG. 5 is a set of diagrams for illustrating a method of determining the relative axial deviation by the vehicle-mounted object detection device 101 according to Embodiment 1. FIG. 5(a) shows a state of detection points at a time T=0 according to the object detection unit 1a, and FIG. 5(b) shows a state of detection points at a time T=1 according to the object detection unit 1b.

As shown in FIG. 5(a), at the time T=0, the detection targets K1, K2, K3, K4 and K5 each as a stationary object are detected by the object detection unit 1a, and as shown in FIG. 5(b), at the time T=1, the detection targets K2, K3, K4 and K5 are detected by the object detection unit 1b.

With respect to four detection points of the detection targets other than the detection target K1 which are detected by each of the object detection unit 1a (coverage Sa, axial center c1) and the object detection unit 1b (coverage Sb, axial center c2); namely, with respect to respective sets of four detection points of the detection targets other than the detection target K1, which are taken out of the detection points of the detection targets K1, K2, K3, K4, K5 detected by the object detection unit 1a (at distances of d1, d2, d3, d4, d5, relative speeds of Vrel1, Vrel2, Vrel3, Vrel4, Vrel5, and horizontal angles of α1, α2, α3, α4, α5, respectively) and the detection points of the detection targets K2, K3, K4, K5 detected by the object detection unit 1b (at distances of d6, d7, d8, d9, relative speeds of Vrel6, Vrel7, Vrel8, Vrel9, and horizontal angles of α6, α7, α8, α9, respectively); when the respective sets of four detection points are detected at the same set of positions on the reference coordinate system, the relative axial deviation determination unit 123 determines that there is no axial deviation (“No” in Step S304). Actually, the detection point on the reference coordinate system is subjected to correction taking into account the motion of the vehicle 20, and is provided with a detection error of the object detection unit, an error in the mounting position or the like, superposed thereon. Thus, in some instances, when each of the differences between the respective detection points on the reference coordinate system is within a predetermined value, it is determined that there is no axial deviation, and in some other instances, the above processing is performed multiple times and the determination is made using the average values.

When the detection point is corrected taking into account the motion of the vehicle 20, for example, processing of so-called “dead reckoning” is performed. The dead reckoning is a technique in which a position is not directly detected but the motion is detected and then a position is acquired as a result from accumulation of respective motions. In the case where the vehicle 20 makes a uniform linear motion at the traveling speed Vego, when the coordinates at the time T1 are shifted in parallel with reference to the coordinates at the time T0, to the extent of Vego×(T1−T0), it is possible to compare, on the same coordinate system, the detection points detected by one of the object detection units at the time T0 and converted into the reference coordinate system, with the detection points detected by another one of the object detection units at the time T1 and converted into the reference coordinate system.

In such a case where the vehicle 20 is turning, it is possible to detect a change in attitude/direction of the vehicle 20 and a change in position of the vehicle 20 from the time T0 to the time T1, by detecting the speed at 100 ms intervals, for example, using a yaw rate sensor, a traveling speed sensor or the like, and then accumulating the respective detection values.

As another method of correcting the detection point taking into account the motion of the vehicle 20, such a method may be employed in which the absolute position of the vehicle 20 is detected using a highly-accurate GPS (Global Positioning System) or the like, to thereby monitor a change in attitude/direction of the vehicle 20 and a change in position of the host vehicle from the time T0 to the time T1. In every case, any type of method may be employed so far as it can convert the detection point into the reference coordinate system so that the relative comparison can be made, taking into account the motion of the vehicle 20, between the object detection units in terms of their respective detection points.

It is noted that the relative axial deviation determination unit 123 may make the determination about a relative axial deviation only when the turning radius of the vehicle 20 is larger than a predetermined threshold value. When the vehicle 20 is turning, at the time of making the relative comparison between the detection points at the time T0 and the time T1, a relative-comparison error may occur to an extent depending on the magnitude of the turning radius. Accordingly, by making the determination about a relative axial deviation only when the turning radius is larger than the predetermined threshold value, namely, only when the vehicle 20 makes a nearly linear motion, it is possible to steadily determine whether there is a relative axial deviation.

When the detection targets K2, K3, K4, K5 detected by the object detection unit 1a and the detection targets K2, K3, K4, K5 detected by the object detection unit 1b are not detected, respectively, at the same positions on the reference coordinate system, thus they are not mutually overlapped, the relative axial deviation determination unit 123 determines that there is an axial deviation (“Yes” in Step S304), and then calculates a relative axial deviation amount (Step S305).

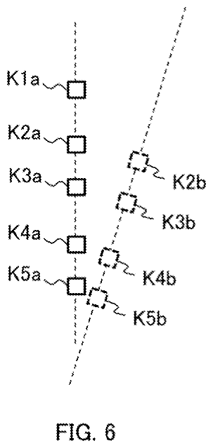

FIG. 6 is a diagram for illustrating a method of estimating the relative axial deviation amount by the vehicle-mounted object detection device 101 according to Embodiment 1. As shown in FIG. 6, respective relative deviation amounts between the detection targets K2a, K3a, K4a, K5a detected by the object detection unit 1a and the detection targets K2b, K3b, K4b, K5b detected by the object detection unit 1b, are deviation amounts detected according to the horizontal axial deviation amount. Thus, it is possible to acquire the horizontal axial deviation amount by estimating the relative deviation amounts.

As a method of estimating the relative deviation amount, for example, such a method is conceivable in which the detection points on the reference coordinate system detected at the time T0 by the object detection unit 1a and the detection points on the reference coordinate system detected at the time T1 by the object detection unit 1b are rotated around their respective mounted positions on the reference coordinate system as references, and a horizontal angle at which the respective detection points have a highest correlation is calculated as the axial deviation amount. As a specific example of algorithm, such an overlapping method between two groups of points that is called an ICP (Interactive Closest Point) method, may be used to derive that amount (see, Patent Document 1).

The distance, the relative speed and the horizontal angle to be detected by an object detection unit at a given detection point, are not always the same between different object detection units. For example, there are such features that the larger the aperture size of the radar device, the higher the accuracy of angle measurement, and that the higher the S/N ratio, the higher the accuracy of angle measurement. Taking into account such features, position adjustment may be performed using weighting based on information about the accuracy of the detection values of the distances, the relative speeds and the horizontal angles by the respective object detection units. At the time of minimizing the distance between the detection points by using the ICP method, position adjustment may be performed, for example, by making the weight of the distance between the detection points larger as their S/N ratios become higher, and making the weight of the distance between the detection points smaller as their S/N ratios become lower.

It is noted that the time T0 and the time T1 may be separated temporally to any extent so far as almost the same regions on the reference coordinate system are monitored at these times. For example, in the case where the object detection unit 1c and the object detection unit 1a are subject to comparison, when the object detection unit 1c and the object detection unit 1a have timings temporally apart from each other, namely, there is a difference of 500 (ms) from when the object detection unit 1a has transmitted an electric wave to when the object detection unit 1c transmits it, it is appropriate, taking into account the motion of the vehicle 20 during 500 (ms), to make the determination about a relative axial deviation by using objects detected both by the object detection unit 1c and the object detection unit 1a in the same regions on the reference coordinate system.

Meanwhile, in the case where the object detection unit 1a and the object detection unit 1b are subject to comparison, since the object detection unit 1a detects objects from a front region whereas the object detection unit 1b detects objects from a rear region, even if the object detection unit 1a and the object detection unit 1b transmit electric waves at almost the same times, a time at which an object corresponding to the detection point of the object detection unit 1a and the detection point of the object detection unit 1b, are detected in the same regions on the reference coordinate system, is after the elapse of a certain period of time. In this case, the detection points of the object detection unit 1a and the detection points of the object detection unit 1b are compared on the reference coordinate system according to their respective timings temporally apart from each other. Here, although a case of using timings temporally apart from each other has been described, the timing difference between the object detection units may be short, which is a parameter to be appropriately set depending on the configuration of the object detection system.

Further, the object detection units subject to comparison have not to be such object detection units that are adjacent to each other, and when they are respective object detection units having their respective regions on the reference coordinate system in which substantially the same objects are to be detected, it is possible to make the comparison. For example, the object detection unit 1c and the object detection unit 1b may be subject to relative comparison according to their temporally shifted timings.

Further, at the time of position adjustment, since the presence of many unnecessary detection points leads to an estimation error, detection points subject to calculation may be limited. For example, according to the object detection units 1a, 1b, 1c, 1d, 1e, the higher the S/N ratio, the higher the accuracy of detection value and thus, in order to improve the accuracy of the relative axial deviation determination unit 123, it is useful to transmit only the data of stationary objects having the S/N ratios each higher than a predetermined threshold value, to where the processing of the next step is performed. Further, when there are multiple objects at almost the same distances and relative speeds, such a case may arise that the object detection unit 1a, 1b, 1c, 1d or 1e cannot distinguish the horizontal angles θ of the respective objects from each other. A method capable of measuring the angles of the objects even when they exist at almost the same distances and relative speeds, is exemplified by angle measurement processing methods based on digital beam forming, MUSIC, ESPRIT, maximum likelihood estimation and the like. However, even when such a method is employed, in some cases, the horizontal angles θ of the respective objects cannot be distinguished from each other, and in some other cases, the accuracy is not sufficient if they could be distinguished from each other. Accordingly, when there are multiple objects at almost the same distances and relative speeds, the data of the objects at these distances and relative speeds may be excluded from the output of the stationary object extraction unit 121. When there are multiple reflection objects at almost the same distances and relative speeds, whether or not to process the data thereof, may be determined according to the accuracy of the angle measurement processing method. Examples of how to make such determination according to the accuracy, may include a method in which, in the case where a same object is being identified in a time-serial manner by the tracking processing, when the horizontal angle of the object varies extremely largely, it is determined that the accuracy is degraded. Meanwhile, another method of determining whether or not multiple reflection objects exist at almost the same distances and relative speeds, is exemplified by a method in which arrival wave number estimation processing is performed that is publicly known in angle measurement processing. Further, a feature in a road structure may be employed. For example, a continuous structure object such as a guard rail or the like has a characteristic shape. Thus, if, out of the acquired detection result, only the data of such a characteristic object in the road structure is transmitted in the subsequent step to the relative axial deviation determination unit 123, the processing in the subsequent step can be accomplished without such a reflection point detected just as a single point due to erroneous detection. This is useful to improve the accuracy of the relative axial deviation determination unit 123.

Subsequently, the misaligned axis identification unit 124 in the control unit 10 identifies the object detection unit whose axis is misaligned (Step S306).

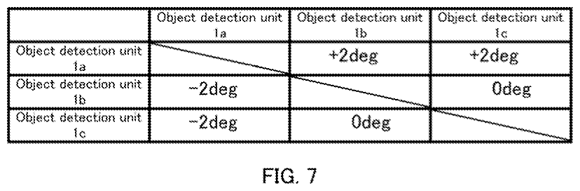

FIG. 7 is a table showing an example of relative axial deviation amounts according to the vehicle-mounted object detection device 101 according to Embodiment 1. In FIG. 7, the axial deviation amounts as estimation values in the case of using information from three object detection units 1a, 1b, 1c, are shown.

In the case where such an estimation result of relative axial deviation amounts is obtained by the relative axial deviation determination unit 123, in which, as shown in FIG. 7, when the object detection unit 1a and the object detection unit 1b are compared with each other, the object detection unit 1b has an axial deviation of +2 deg with respect to the object detection unit 1a, and the object detection unit 1a has an axial deviation of −2 deg with respect to the object detection unit 1b; when the object detection unit 1a and the object detection unit 1e are compared with each other, the object detection unit 1c has an axial deviation of +2 deg with respect to the object detection unit 1a, and the object detection unit 1a has an axial deviation of −2 deg with respect to the object detection unit 1c; and when the object detection unit 1b and the object detection unit 1c are compared with each other, the object detection unit 1c has an axial deviation of 0 deg with respect to the object detection unit 1b, and the object detection unit 1b has an axial deviation of 0 deg with respect to the object detection unit 1c; it is not possible, only by the comparison between the object detection unit 1a and the object detection unit 1b, to recognize whether the axis of the object detection unit 1a is misaligned or the axis of the object detection unit 1b is misaligned; however, by the comparison between the object detection unit 1a, the object detection unit 1b and the object detection unit 1c, it is possible to identify that such a failure occurs in the object detection unit 1a. This identification is based on the thought that, both in the object detection unit 1b and the object detection unit 1c, exactly the same degree of misalignment would rarely occur.

It is noted that the method of identifying the object detection unit whose axis is misaligned is not limited to the above. When at least one of the object detection units has a function of calculating an absolute amount of its horizontal axial deviation, the misaligned axis identification unit. 124 can identify the object detection unit whose horizontal axis is misaligned, by using the absolute horizontal axial deviation amount and the aforementioned relative axial deviation amount. For example, it is possible to determine the horizontal directionality of an object detection unit, namely, the absolute horizontal axial deviation amount thereof, by calculating the direction toward a speed-zero detection point that is a detection point which is to be placed in a direction at 90 deg relative to a front-rear direction of the vehicle 20 and at which the relative speed is zero. Thus, it is possible to determine which object detection unit has caused a horizontal axial misalignment, by using the absolute axial deviation amount acquired solely by one object detection unit.

Lastly, the misaligned axis identification unit 124 in the control unit 10 corrects the relative axial deviation amount of the thus-identified object detection unit (Step S307), so that the operations of the vehicle-mounted object detection device 101 are completed. Accordingly, because the horizontal axial misalignment is corrected, the device can continue proper operations as a whole.

In a method for such correction, the acquired measured angle value may be corrected by software to an extent corresponding to the horizontal axial deviation amount, or may be corrected in such a mechanical manner that a mechanism for horizontally rotating the object detection unit or an antenna part that constitutes the object detection unit is provided, and the object detection unit or the antenna part that constitutes the object detection unit is horizontally corrected to an extent corresponding to the horizontal axial deviation amount.

It is noted that when the absolute axial deviation amount is acquired, using that value, the axial deviation amount may be corrected. This correction may be performed when the absolute value of the horizontal axial deviation amount is equal to or more than a predetermined correction reference value.

The vehicle control unit 2a is informed of the relative axial deviation amount when the misaligned axis identification unit 124 has no function of such correction, when the misaligned axis identification unit cannot fully correct the relative axial deviation amount, or when an amount to be corrected is too large and thus, obviously, the axis of the radar itself is suspected to be largely misaligned due to a minor collision or the like. This makes it possible, for example, to suspend the operation of vehicle control application executed by the vehicle control unit 2a, or to restrict the operation of a part of the functions.

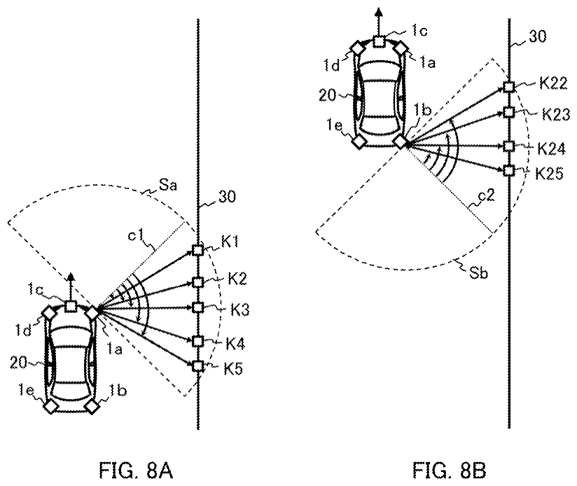

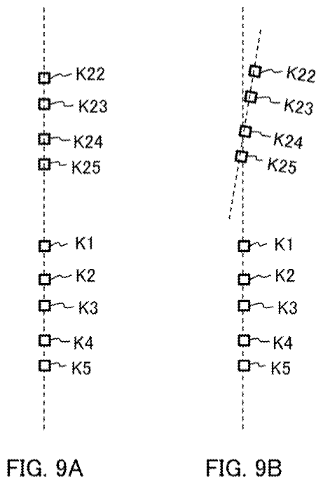

Further, in the foregoing embodiment, the respective sets of detection points detected in regions that are almost the same between the object detection units, are compared with each other; however, this is not limitative. FIG. 8 and FIG. 9 are each a set of diagrams for illustrating another method of determining a relative axial deviation by the vehicle-mounted object detection device 101 according to Embodiment 1. Assuming a case, for example, where the vehicle 20 is going straight ahead on a freeway provided with a guardrail 30 as shown in FIG. 8 and FIG. 9, since the guardrail 30 is generally disposed in a linear state, this feature may be employed. Thus, the detection points of the detection targets K1, K2, K3, K4, K5 (see, FIG. 8(a)) detected by the object detection unit 1a at a time T0 are compared, on the reference coordinate system, with the detection points of detection targets K22, K23, K24, K25 (see, FIG. 8(b)) measured by the object detection unit 1b at a time T1, so that, when they are aligned in a same straight line, it may be determined that there is no axial misalignment (see, FIG. 9(a)), and when they are not aligned in a same straight line, it may be determined that there is an axial misalignment (see, FIG. 9(b)).

Further, the vehicle 20 does not necessarily go straight ahead. This corresponds to the scene in which the shape of a structure object can be predicted, which is exemplified by: a case where a continuous structure object (a guardrail, a wall or the like) is placed along a curve ahead of the vehicle 20; a case where the shape of a structure object is already found according to a map information, etc.; or the like.

Further, in the foregoing embodiment, such cases have been described where the two units as the object detection unit 1a and the object detection unit 1b are subjected to relative comparison, and where the three units as the object detection unit 1a, the object detection unit 1b and the object detection unit 1c are subjected to relative comparison; however, according to this application, the number of the object detection units is not limited, and any number thereof is employable so far as two or more such object detection means are mounted.

Further, the coordinate conversion is not an essential component. Thus, any type of method may be employed so far as it can make a calculation based on the relative comparison between the respective sets of detection points detected at different times by the multiple object detection units. For example, the calculation may be made in such a manner that conditions are sought that are required for causing the detection points acquired at a time T0 by the object detection unit 1a and the detection points acquired at a time T1 by the object detection unit 1b, to be overlapped with each other, and then, from such conditions for overlapping, a factor due to the motion of the vehicle 20 and a factor due to mounted horizontal angles of the object detection units, are subtracted.

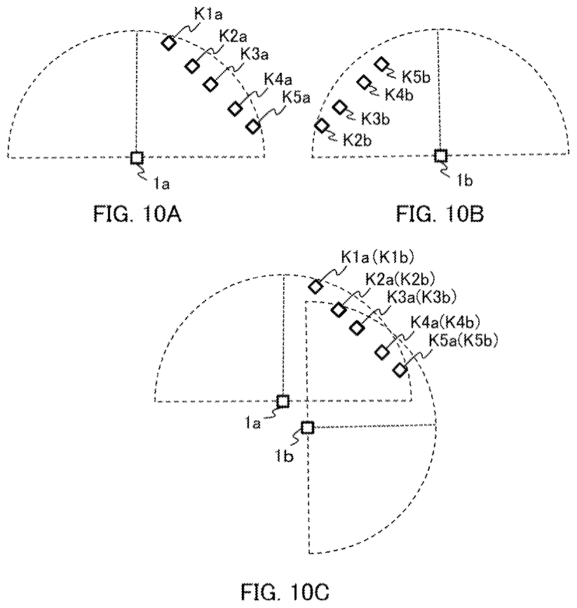

FIG. 10 is a set of diagrams for illustrating another method of determining a relative axial deviation by the vehicle-mounted object detection device 101 according to Embodiment 1. In the case where no coordinate conversion is performed, the detection points of the detection targets K1a, K2a, K3a, K4a, K5a according to the object detection unit 1a, and the detection points of the detection targets K1b, K2b, K3b, K4b, K5b according to the object detection unit 1b, are indicated as shown in FIG. 10(a) and FIG. 10(b), respectively, with reference to the respective object detection units.

In order to cause the detection points of the detection targets K1a, K2a, K3a, K4a, K5a according to the object detection unit 1a, and the detection points of the detection targets K1b, K2b, K3b, K4b, K5b according to the object detection unit 1b, to be overlapped with each other, it suffices to rotate the detection points of the object detection unit 1b by 90 deg and then to shift them in parallel as shown in FIG. 10(c). The parallel shift amount is a value to be determined depending on the mounted position, the moved amount of the vehicle 20 from the time T0 to the time T1, and the like. The rotation amount is a value to be determined depending on the mounted horizontal angles of the object detection unit 1a and the object detection unit 1b, the rotational motion of the vehicle 20 from the time T0 to the time T1, and the like. In this case, because the difference between the mounted initial horizontal angles of the object detection unit 1a and the object detection unit 1b is 90 deg, when the rotation amount and the difference between the mounted initial horizontal angles of the radars are compared with each other, it is possible to determine whether or not the axes of the object detection unit 1a and the object detection unit 1b axe deviated from each other. As an overlapping method of such groups of points, any type of method may be performed. For example, it is appropriate to achieve such overlapping by using an algorithm of the aforementioned ICP method or the like.

As described above, according to the vehicle-mounted object detection device 101 according to Embodiment 1, it comprises: the multiple object detection units 1a, 1b, 1c, 1d, 1e each serving to detect positional information about detection targets K1, K2, K3, K4, K5 as stationary objects; the stationary object extraction unit 121 for extracting, from respective sets of positional information detected by two object detection units 1a, 1b in the multiple object detection units 1a, 1b, 1c, 1d, 1e about their respective sets of detection targets K1, K2, K3, K4, K5, positional information about the multiple detection targets K2, K3, K4, K5 that are common between the respective sets of detection targets; and the relative axial deviation determination unit 123 for making a comparison between the positional information detected by the object detection unit 1a in the two object detection units 1a, 1b about the multiple detection targets K2, K3, K4, K5 and the positional information detected, after detection about the multiple stationary objects K2, K3, K4, K5 by the object detection unit 1a, by the object detection unit 1b in the two object detection units 1a,1b about the multiple detection targets K2, K3, K4, K5, to thereby determine presence/absence of an axial deviation of a central axis of the object detection unit 1a or the object detection unit 1b. Thus, it is possible to detect an axial deviation amount without causing the detection regions of such multiple detectors to be overlapped with each other. Further, when the horizontal axial misalignment is corrected, it is possible to continue proper operations.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

### DESCRIPTION OF REFERENCE NUMERALS AND SIGNS

1a, 1b, 1c, 1d, 1e: object detection unit, 121: stationary object extraction unit, 123: relative axial deviation determination unit, 101: vehicle-mounted object detection device.

1-10. (canceled)

11. A vehicle-mounted object detection device, comprising:
multiple object detectors each serving to detect positional information about stationary objects;
a stationary object extractor for extracting, from respective sets of positional information detected by two object detectors in the multiple object detectors about their respective sets of stationary objects, positional information about multiple stationary objects that are common between the respective sets of stationary objects; and
an axial deviation determinator for making a comparison between the positional information detected by one object detector in the two object detectors about the multiple stationary objects, and the positional information detected, after detection about the multiple stationary objects by the one object detector, by the other object detection unit in the two object detectors about the multiple stationary objects, to thereby determine presence/absence of an axial deviation of a central axis of the one object detector or the other object detector.

12. The vehicle-mounted object detection device according to claim 11, further comprising a reference coordinate conversion unit for converting coordinates of the positional information extracted by the stationary object extractor about the multiple stationary objects, into a common reference coordinate system among the multiple object detectors.

13. The vehicle-mounted object detection device according to claim 12, wherein the axial deviation determinator calculates a relative axial deviation amount on a basis of the positional information about the multiple stationary objects converted to the coordinates on the common reference coordinate system by the reference coordinate conversion unit.

14. The vehicle-mounted object detection device according to claim 13, wherein the axial deviation determinator calculates the relative axial deviation amount on a basis of locations of the multiple stationary objects based on the positional information of the multiple stationary objects.

15. The vehicle-mounted object detection device according to claim 13, wherein the multiple object detectors are three or more object detectors, and the relative axial deviation amount is calculated for every set of two of the multiple object detectors; and which further comprises a misaligned axis identification unit for identifying the object detector whose axis is misaligned, by using a set of the thus-calculated relative axial deviation amounts.

16. The vehicle-mounted object detection device according to claim 13, wherein at least one of the object detectors calculates its absolute axial deviation amount by using the positional information detected thereby; and which further comprises a misaligned axis identification unit for identifying the object detector whose axis is misaligned, by using the absolute axial deviation amount and the relative axial deviation amount.

17. The vehicle-mounted object detection device according to claim 15, wherein the misaligned axis identification unit corrects the misaligned axis of the thus-identified object detector according to the relative axial deviation amount.

18. The vehicle-mounted object detection device according to claim 16, wherein the misaligned axis identification unit corrects the misaligned axis according to the absolute axial deviation amount when the absolute axial deviation amount is equal to or more than a predetermined correction reference value.

19. The vehicle-mounted object detection device according to claim 13, wherein the axial deviation determinator informs a vehicle control unit about the relative axial deviation amount.

20. The vehicle-mounted object detection device according to claim 14, wherein the axial deviation determinator informs a vehicle control unit about the relative axial deviation amount.

21. The vehicle-mounted object detection device according to claim 11, wherein the axial deviation determinator determines presence/absence of the axial deviation, when a turning radius of a vehicle is more than a predetermined threshold value.
